(19) United States
(12) Patent Application Publication
(10) Pub. No.: US 2005/0048196 A1
(43) Pub. Date: Mar. 3, 2005

(54) Control and system for dispensing fluid material

(76) Inventors: Akihiro Yanagita, Orion Township, MI (US); Raymond Guzowski, Fenton, MI (US); Kishore Lankalapalli, Rochester Hills, MI (US); Karl F. Wirth, Lake Orion, MI (US); David Bruce, Windsor (CA)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/738,841

(22) Filed: Dec. 17, 2003

Related U.S. Application Data
(63) Continuation-in-part of application No. 10/649,977, filed on Aug. 26, 2003.

(51) Int. Cl. B05D 1/00; B05C 11/00

(52) U.S. Cl. 427/8; 427/421.1; 118/663; 118/688

(57) ABSTRACT

A method for controlling a fluid delivery system that includes a controllable pressure regulating device, a pressure sensor, a flow meter, and a controller. Initial values of a compensation factor and a cracking pressure are established, and a pressure of the fluid at each of a plurality of time increments occurring during periods while the fluid is dispensed is measured. A volume of the fluid dispensed during a first period, an average pressure at the time internals during the first period, and an actual average flow rate during the first period are determined. Then the average pressure value, the average flow rate value, a new compensation factor and a new cracking pressure are used to determine a theoretical flow rate for controlling the pressure regulating device and producing a pressure corresponding to the target flow rate.

### REFERENCE TO RELATED APPLICATION

This application is a continuation-in-part of prior application Ser. No. 10/649, 977, filed Aug. 26, 2003.

### BACKGROUND OF THE INVENTION

Dispensing systems are well known in industrial applications for dispensing viscous materials such as sealants, adhesives, coatings, and the like onto a workpiece. These applications may be to seal the workpiece, to adhere the workpiece to another structure, or to coat the workpiece. Changes in the viscosity of the viscous material being dispensed, wear of components of the dispensing system, and operating abnormalities such as air bubbles within the dispensing system are common in such dispensing systems. The changes in operational characteristics of the viscous material and the dispensing system continuously impact an actual dispensing rate of the viscous material. As a result, the prior art has attempted to provide methods to compensate the actual dispensing rate to account for such changes.

Dispensing systems are well known in industrial applications for dispensing viscous materials such as sealants, adhesives, coatings, and the like onto a workpiece. These applications may be to seal the workpiece, to adhere the workpiece to another structure, or to coat the workpiece. Changes in the viscosity of the viscous material being dispensed, wear of components of the dispensing system, and operating abnormalities such as air bubbles within the dispensing system are common in such dispensing systems. The changes in operational characteristics of the viscous material and the dispensing system continuously impact an actual dispensing rate of the viscous material. As a result, the prior art has attempted to provide methods to compensate the actual dispensing rate to account for such changes.

One such method is shown in U.S. Pat. No. 5,054,650 to Price, issued Oct. 8, 1991. Price discloses a method of controlling a dispensing system to dispense a viscous material onto a workpiece. Specifically Price discloses a method of compensating an actual dispensing rate of the viscous material to maintain the actual dispensing rate within a minimum deviation of a target dispensing rate. However, Price discloses a method for compensating the actual dispensing rate only once per job cycle. This periodic compensation frequency does not account for the dynamic characteristics of the viscous materials during each job cycle and the operating abnormalities that maybe encountered during each job cycle.

Another prior art method is shown in U.S. Pat. No. 5,475,614 to Tofte et al., issued Dec. 12, 1995. Tofte et al. discloses a method of controlling a dispensing system to dispense chemicals onto a field. Specifically, Tofte et al. discloses a method of compensating an actual dispensing rate of the chemicals to account for wear of components of the dispensing system thereby maintaining the actual dispensing rate within a minimum deviation of a target dispensing rate.

The method includes dispensing the chemicals onto the field during a first time period and measuring a pressure of the chemicals after each of a plurality of time increments within the first time period as the chemicals are dispensed. The method continues by determining the theoretical volume of the chemicals dispensed during the first time period based on the pressure measurements during the first time period and an initial compensation factor. An actual volume of the chemicals dispensed during the first time period is simultaneously measured. The theoretical volume dispensed during the first time period is then compared to the actual volume dispensed during the first time period and a first new value for the compensation factor is derived therefrom.

The method of Tofte et al. continues by dispensing the chemicals onto the field during a second time period and measuring a pressure of the chemicals after each of a plurality of time increments within the second time period. The method continues, as before, by determining a theoretical volume of the chemicals dispensed during the second time period based on the pressure measurements during the second time period and the first new value for the compensation factor. An actual volume of the chemicals dispensed during the second time period is simultaneously measured. The controller then compares the theoretical and actual volumes of the chemicals dispensed during the second time period and derives a second new value for the compensation factor therefrom. Tofte et al. discloses that the second time period is periodically spaced from the first time period. Tofte et al. is primarily concerned with nozzle wear that occurs during dispensing of the chemicals. Hence, the periodically spaced time periods disclosed by Tofte et al. are sufficient to compensate for such wear since such wear is not immediate, i.e., occurs over several time periods. Conversely, periodically spaced time periods are not sufficient to compensate for changes in viscosity of a viscous material during dispensing. In this case, new values for the compensation factor must be continuously determined.

In summary Tofte et al. discloses using the compensation factor to compensate the actual dispensing rate to maintain the actual dispensing rate within the minimum deviation from—the target dispensing rate. The compensation factor is recalculated in each time period, e.g., the first and second new values for the compensation factor are determined, by comparing the actual and theoretical volumes of the chemicals dispensed during each of the time periods. The time periods are periodically spaced from one another.

### SUMMARY OF THE INVENTION

The present invention provides a method for controlling a fluid delivery system that includes a controllable pressure regulating device, a pressure sensor, a flow meter, and a controller. Initial values of a compensation factor and a cracking pressure are established, and a pressure of the fluid at each of a plurality of time increments occurring during periods while the fluid is dispensed is measured. A volume of the fluid dispensed during a first period, an average pressure at the time internals during the first period, and an actual average flow rate during the first period are determined. Then the average pressure value, the average flow rate value, a new compensation factor and a new cracking pressure are used to determine a theoretical flow rate for controlling the pressure regulating device and producing a pressure corresponding to the target flow rate. The new compensation factor and new cracking pressure are both calculated values. The theoretical flow rate is calculated using a least square technique.

The method is characterized by at least a portion of the second time period occurring consecutively with the first time period to compensate for changes in operational characteristics of the viscous material and the dispensing system thereby maintaining the actual dispensing rate within the minimum deviation of the target dispensing rate.

The present invention provides several advantages over the prior art, including Tofte et al. For instance, by determining the second new value for the compensation factor consecutively with determining the first new value for the compensation factor, the dispensing system can more quickly compensate the actual dispensing rate in the second time period for the changes in operational characteristics of the viscous material and the dispensing system during the first time period. Such changes include changes in viscosity, air bubbles in the dispensing system, plugged nozzles, and the like. As previously discussed, these changes can have an immediate impact on the actual dispensing rate of the viscous material. For instance, a change in viscosity requires immediate compensation to ensure that the viscous material is being dispensed within the minimum deviation of the target dispensing rate. The dispensing system and method of controlling the dispensing system of the present invention accomplish this by continually determining a new value for the compensation factor, i.e., recalculating the compensation factor. As a result, the method of the present invention provides a better quality seal in the case of the viscous material being a sealant, and saves costs by reducing excessive dispensing.

### DESCRIPTION OF THE DRAWINGS

Advantages of the present invention will be readily appreciated as the same becomes better understood by reference to the following detailed description when considered in connection with the accompanying drawings wherein:

FIG. 1 is a schematic view of a dispensing system of the present invention;

FIG. 2 is a perspective view of a robot used in the dispensing system of the present invention;

FIG. 3 is a graph illustrating changes in voltage applied to a variable orifice servo valve of the present invention during first and second time periods;

FIG. 4 is a graph illustrating changes in theoretical and actual volumes of viscous material dispensed during the first and second time periods;

FIG. 5 is a graph illustrating changes in theoretical and actual volumes of the viscous material relative to a target volume during the first and second time periods;

FIG. 6 is a graph illustrating changes in theoretical and actual volumes of the viscous material dispensed during first and second time periods in an alternative embodiment of the present invention;

FIG. 7 shows curves representing the trend of delivery rate-pressure data sets that would result with various values of N;

FIG. 8 is a graph showing pressure-delivery rate data sets concentrated in a narrow range; and

FIG. 9 is a graph showing pressure-delivery rate data sets distributed in a wider range than that of FIG. 8.

### DESCRIPTION OF THE PREFERRED EMBODIMENT

Referring to the Figures, wherein like numerals indicate like or corresponding parts throughout the several views, a dispensing system for dispensing a viscous material 10 onto a workpiece 12 at an actual dispensing rate that is within a minimum deviation of a target dispensing rate is generally shown at 14.

Dispensing System

The dispensing system 14 of the present invention is preferably used in industrial applications that require accurate dispensing of the viscous material 10 onto the workpiece 12. Such applications may include, but are not limited to, dispensing paint onto the workpiece 12, dispensing sealant onto the workpiece 12 to seal the workpiece 12 from moisture, or dispensing an adhesive onto the workpiece 12 to affix the workpiece 12 to a separate structure.

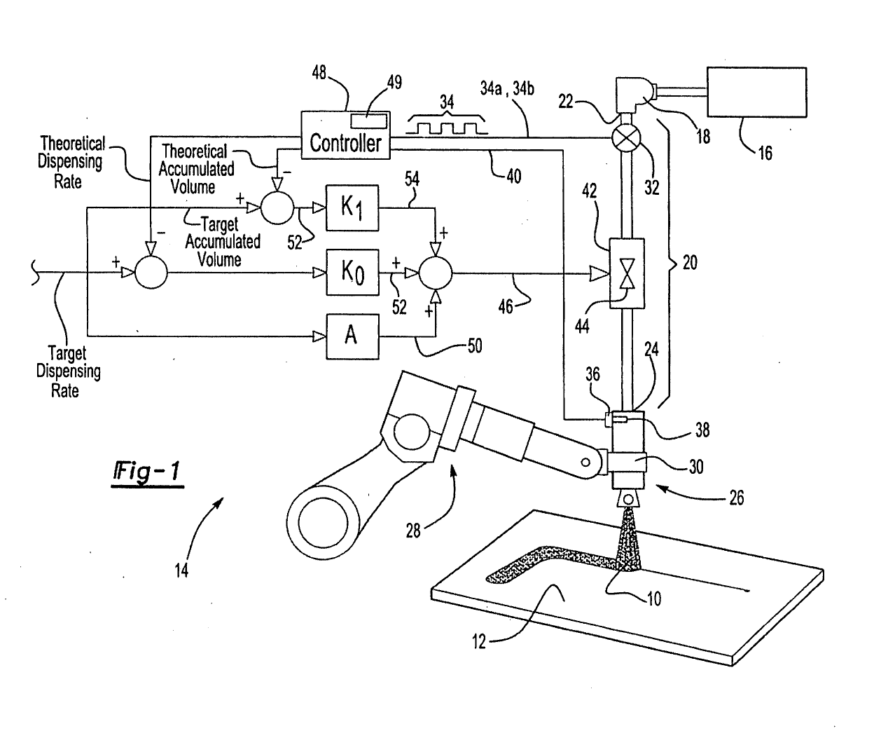

Referring to FIG. 1, a container 16 stores the viscous material 10 to be dispensed. A pump 18 receives the viscous material 10 from the container 16 and conveys the viscous material 10 through a delivery conduit 20 having upstream 22 and downstream 24 ends. The delivery conduit 20, in turn, carries the viscous material 10 toward the workpiece 12.

A nozzle 26 is coupled to the delivery conduit 20 at the downstream end 24. The nozzle 26 directs the viscous material 10 onto the workpiece 12 while the pump 18, which is coupled to the delivery conduit 20 at the upstream end 22, conveys the viscous material 10 through the delivery conduit 20 to the nozzle 26.

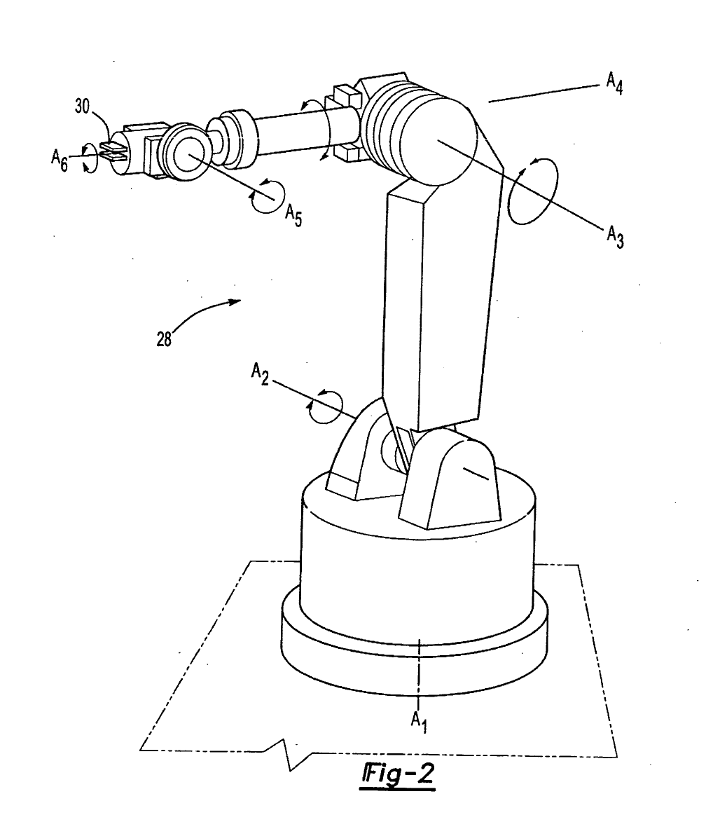

Referring to FIGS. 1 and 2, a robot 28 is used to control a position of the nozzle 26 relative to the workpiece 12 while the viscous material 10 is dispensed from the nozzle 26. More specifically, the robot 28 includes a robot arm 36 that engages the nozzle 26 to move the nozzle 26 to control positioning of the nozzle 26 relative to the workpiece 12. Those skilled in the art understand that the robot arm 30 could also engage the workpiece 12 near the nozzle 26 and move the workpiece 12 relative to the nozzle 26. In this instance, the nozzle 26 would be fixed. The robot 28 defines six rotational axes A1-A6 for rotating thereabout. The robot 28 is preferably a dispensing robot that is modularly constructed and electric servo-driven.

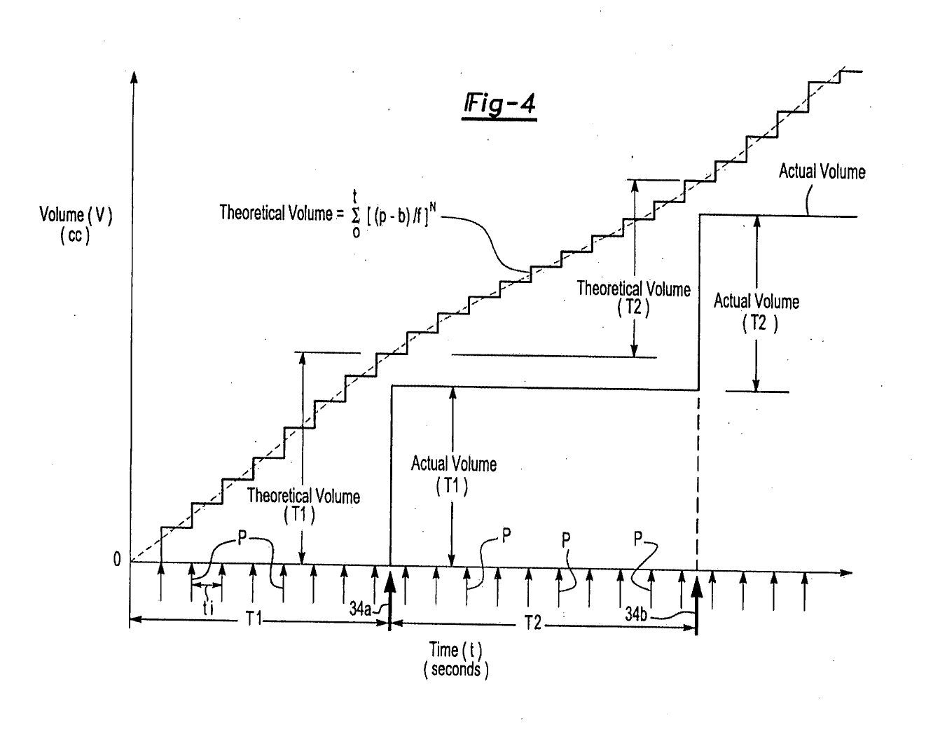

A flow meter 32 is coupled to the delivery conduit 20 to measure an actual volume of the viscous material 10 dispensed onto the workpiece 12. The flow meter 32 is positioned downstream of the pump 18 and upstream of the nozzle 26. The flow meter 32 is preferably a screw-type or gear-type volumetric flow meter 32 that transmits an electrical pulse 34 after a preset volume of the viscous material 10 has passed therethrough. Hence, the actual volume measured by the flow meter 32 is always the preset volume. In a typical dispensing application, the flow meter 32 transmits a pulse 34 every 0.09 to 0.120 seconds, thereby indicating that the preset volume of viscous material 10 has passed therethrough. For instance, referring briefly to FIG. 4, a first pulse 34a indicates that the preset volume of the viscous material 10 has passed through the flow meter 32 during a first time period T1 and the second pulse 34b indicates that the preset volume of the viscous material 10 has passed through the flow meter 32 during a second time period T2, consecutive with the first time period T1. In a typical dispensing application, which dispenses a total volume hundreds of times larger than the preset volume, a stream of pulses 34 is transmitted.

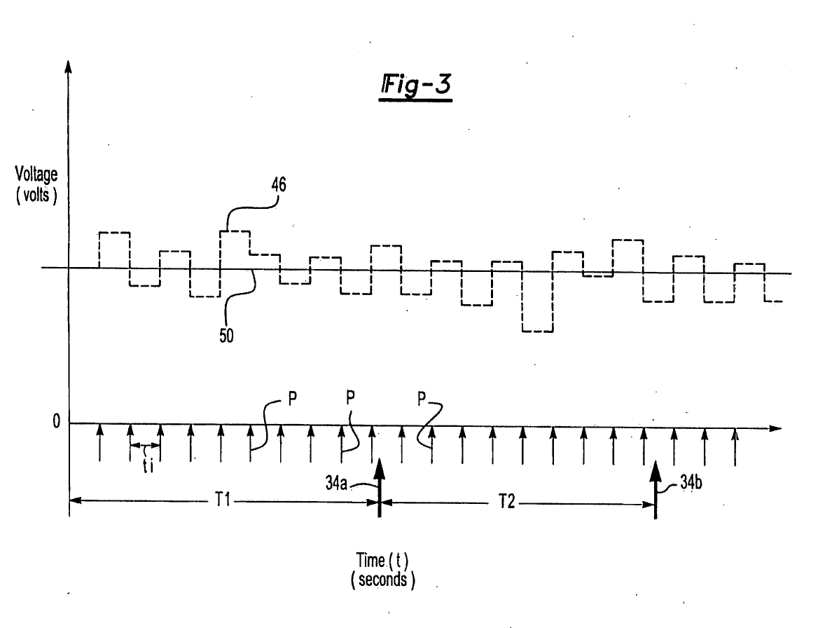

Referring back to FIG. 1, a pressure sensor 36 is positioned at the nozzle 26 to measure a pressure of the viscous material 10 as the viscous material 10 is dispensed onto the workpiece 12. The pressure sensor 36 includes a transducer 38 positioned within the nozzle 26 that transmits a control signal 40 that varies as the pressure of the viscous material 10 within the nozzle 26 varies. The pressure sensor 36 measures the pressure after each of a plurality of time increments ti while the viscous material 10 is being dispensed. In the preferred embodiment, each of the plurality of time increments ti are 0.008 seconds. Hence, in a typical dispensing application, referring back to the frequency of pulses 34 from the flow meter 32, several pressure measurements P are taken for every pulse 34 transmitted by the flow meter 32. See FIGS. 3-6.

A pressure regulator 42 is coupled to the delivery conduit 20 to control the actual dispensing rate that the viscous material 10 is dispensed through the nozzle 26 and onto the workpiece 12. The pressure regulator 42 includes a variable orifice servo valve 44 that is electronically responsive to an output signal 46 to open and close the variable orifice servo valve 44 thereby changing the actual dispensing rate. The output signal 46 comprises a voltage to be applied to the variable orifice servo valve 44 to maintain a position of the variable orifice servo valve 44. Additions or reductions to the voltage adjusts the variable orifice servo valve 44 to ensure that the viscous material 10 is being dispensed within the minimum deviation of the target dispensing rate, as will be described further below. Operation of the flow meter 32, pressure sensor 36, and pressure regulator 42 are well known to those skilled in the art and will not be described in further detail.

A controller 48 having a microprocessor 49 is operatively and electrically connected to the flow meter 32, the pressure sensor 36, and the pressure regulator 42. The controller 48 is programmed to receive and interpret the pulses 34 transmitted by the flow meter 32 to measure the actual volume of the viscous material 10 dispensed over time. The controller 48 is also programmed to receive and interpret the control signal 40 generated by the pressure sensor 36 to determine a theoretical volume of the viscous material 10 dispensed onto the workpiece 12 overtime. The controller 48 compares the theoretical volume and the actual volume to derive new values for a compensation factor f, as will be described further below.

It should be appreciated by those skilled in the art that alternative configurations of the dispensing system 14 could also be envisioned without departing from the spirit of the present invention.

Method of Controlling the Dispensing System

In typical dispensing applications, the viscous material 10, e.g., urethanes, silicones, butyls, hot-melt materials, and the like, may have a standard viscosity between 10,000 and 500,00 cP (mPa·s). In addition, the viscosity of the viscous material 10 may vary due to temperature, shear thinning or thickening, and batch-to-batch changes. At the same time, changes in the dispensing system 14 may occur such as wear of components, e.g., wear of the nozzle 26, plugging of the nozzle 26, air bubbles within the dispensing system 14, the viscous material 10 settling during breaks, and the like. The dispensing system 14 of the present invention utilizes the compensation factor f and closed loop control to compensate the actual dispensing rate of the viscous material 10 for changes in these operational characteristics of the viscous material 10 and the dispensing system 14 such that the actual dispensing rate is maintained within the minimum deviation of the target dispensing rate. The minimum deviation represents an acceptable tolerance in the actual dispensing rate. Typically, such tolerances are on the order of ten percent, i.e., the actual dispensing rate is within ten percent of the target dispensing rate.

Operation of the Dispensing System

Operation of the dispensing system 14 is based on the pressure measurements P taken while dispensing the viscous material 10 onto the workpiece 12. In other words, dispensing of the viscous material 10 onto the workpiece 12 is pressure controlled.

Referring to FIG. 3, the pressure of the viscous material 10 is measured after each of the plurality of time increments ti as the viscous material 10 is dispensed. As previously noted, the pressure sensor 36 transmits the control signal 40 to the controller 48 after each of the plurality of time increments ti and the controller 48, receiving the control signal 40, converts the control signal 40 into the press-are measurements P.

A theoretical dispensing rate is determined after each pressure measurement P is taken. These theoretical dispensing rates are determined using the equation,
theoretical dispensing rate=[P−b)/f]^{N}
wherein f is the compensation factor, b is a cracking pressure, P is the pressure measurement, and N is the linearity factor. The cracking pressure b represents the minimum pressure for the viscous material 10 to begin dispensing from the dispensing system 14 onto the workpiece 12. i.e., the cracking pressure b compensates for frictional losses within the dispensing system 14. The linearity factor N corresponds to shear thinning or shear thickening properties of the viscous material 10. For instance, the linearity factor N may be less than one for shear-thickening, greater than one for shear-thinning, and equal to one for linear material. As will be appreciated by those skilled in the art, the cracking pressure b and linearity factor N can be established based on trial and error using the above equation or by other methods such as manufacturer's suggestions and the like. Determination, e.g., calculation, of the compensation factor f is described further below.

Referring back to FIG. 1, after each of the plurality of time increments ti, the corresponding theoretical dispensing rate is compared to the target dispensing rate. The dispensing system 14 is then adjusted based on the difference between the theoretical dispensing rate and the target dispensing rate. More specifically, the variable orifice servo valve 44 is adjusted. For example, if the theoretical dispensing rate is greater than the target dispensing rate, the variable orifice servo valve 44 partially closes flow of the viscous material 10, and if the theoretical dispensing rate is less than the target dispensing rate the variable orifice servo valve 44 partially opens flow of the viscous material 10.

The variable orifice servo valve 44 is adjusted by adjusting the voltage of the output signal 46 applied thereto. In the preferred embodiment, the voltage of the output signal 46 comprises a base voltage 50, a first voltage adjustment 52, and a second voltage adjustment 54. The base voltage is predefined, for example, by a relationship such as
base voltage−A*target dispensing rate+initial voltage
wherein A is a constant. Referring specifically to FIG. 1, once the difference between the theoretical dispensing rate and the target dispensing rate is determined after each time increment, the difference is multiplied by a first voltage constant K₀ to determine the first voltage adjustment 52. The first voltage adjustment 52 can be an addition or reduction of the voltage of the output signal 46 applied to the variable orifice servo valve 44 to ensure that the actual dispensing rate is within the minimum deviation of the target dispensing rate. The second voltage adjustment 54 is described further below in reference to additional compensation routines.

This method of controlling the dispensing system 14 to dispense the viscous material 10 would not be ideal without the compensation factor f to determine the theoretical dispensing rate. Controlling the dispensing system 14 based on the theoretical dispensing rate, without the compensation factor f, would not account for many of the changes in the operating characteristics of the viscous material 10 and the dispensing system 14. Hence, the dispensing system 14 would be prone to errors, resulting in wasted time and increased product defects. For this reason, the compensation factor f is utilized.

Determining the Compensation Factor

The compensation factor f is utilized during operation of the dispensing system 14 to compensate the actual dispensing rate and maintain the actual dispensing rate within the minimum deviation of the target dispensing rate. The compensation factor f, therefore, must be continuously updated, i.e., recalculated, to compensate for changes in the operational characteristics of the viscous material 10 and the dispensing system 14.

The compensation factor f is determined, i.e., recalculated, after every pulse 34 that is transmitted to the controller 48 by the flow meter 32. Since the flow meter 32 can provide accurate volumetric measurements of the viscous material 10 dispensed over a given time period, these measurements are used to determine the compensation factor f. Of course, as previously noted, these measurements occur approximately once every 0.09 to 0.12 seconds in a typical dispensing application.

The compensation factor f is determined during operation of the dispensing system 14, i.e., while dispensing the viscous material 10 onto the workpiece 12. As the viscous material 10 is dispensed, the pressure measurements P are being taken after each of the plurality of time increments ti. Referring to FIG. 4, a theoretical volume of the viscous material 10 dispensed during a first time period T1 is determined based on the pressure measurements P taken during the first time period T1 and an initial value fᵢₙᵢₜᵢₐₗ for the compensation factor f. The theoretical volume of the viscous material 10 dispensed over the first time period T1 is determined using the equation,
theoretical volume=Σ_{TI}[(Pₜᵢ−b)/fᵢₙᵢₜᵢₐₗ^{N}
wherein fᵢₙᵢₜᵢₐₗ is the initial value for the compensation factor f, b is the cracking pressure, Pₜᵢ is the pressure measurement taken at each time increment ti within the first time period T1, and N is the linearity factor. Since this is the first time period T1 in the dispensing application, the compensation factor f has not yet been determined. Hence, the initial value for the compensation factor is arbitrarily selected. As will be seen, however, this arbitrary selection is corrected after the first time period T1.

At the same time, the actual volume of the viscous material 10 dispensed during the first time period T1 is measured. In the preferred embodiment, this is simply the preset volume of the flow meter 32, i.e., the volume of the viscous material 10 dispensed between commencement of dispensing at time equals zero in FIG. 4, and the first pulse 34a from the flow meter 32, also shown in FIG. 4. The controller 48 compares the theoretical and actual volumes of the viscous material 10 dispensed during the first time period T1 to determine a first new value F₁ for the compensation factor f.

In particular, the actual volume is equated to the theoretical volume in the equation,
theoretical volume=Σ_{TI}[(Pₜᵢ−b)/f1]^{N}
wherein F₁ is the first new value for the compensation factor f, b is the cracking pressure, Pₜᵢ is the pressure measurement taken at each time increment ti within the first time period T1, and N is the linearity factor. The first new value f₁ for the compensation factor f is determined by rearranging this equation as follows,
f₁=Σ_{TI}[(Pₜᵢ−b)/actual volume]^{(1/N)}

The first new value f₁ for the compensation factor f accounts for changes in operational characteristics of the viscous material 10 and the dispensing system 14 that occurred during the first time period T1. Hence, the first new value f₁ for the compensation factor f can now be used for normal operation of the dispensing system 14 in a second time period T2, consecutive with the first time period T1.

Still referring to FIG. 4, the method continues by dispensing the viscous material 10 onto the workpiece 12 during the second time period T2. The same steps carried out for the first time period T1 are performed during the second time period T2 to determine a-second new value f₂ for the compensation factor f for the second time period T2, namely, measuring a pressure of the viscous material 10 after each of a plurality of time increments ti within the second time period T2, determining a theoretical volume of the viscous material 10 dispensed during the second time period T2 based on the pressure measurements P during the second time period T2 and the first new compensation factor f₁, measuring an actual volume of the viscous material 10 dispensed during the second time period T2, and comparing the theoretical and actual volumes of the viscous material 10 dispensed during the second time period T2 to determine the second new value f₂ for the compensation factor f based on the comparison between the theoretical and actual volumes of the viscous material 10 dispensed during the second time period T2. As will be appreciated, the second new value f₂ for the compensation factor f would be utilized while dispensing the viscous material 10 in a third time period (not shown) consecutive with the second time period T2.

The method of determining the first f₁ and second f₂ new values for the compensation factor f is characterized by at least a portion of the second time period T2 occurring consecutively with the first time period T1 to compensate the actual dispensing rate in the second time period T2 for changes in the operational characteristics of the viscous material 10 and the dispensing system 14 that occurred in the first time period T1 thereby maintaining the actual dispensing rate within the minimum deviation of the target dispensing rate. By continuously recalculating new values for the compensation factor f, changes in viscosity of the viscous material 10, wear of the nozzle 26, occurrences of the nozzle 26 being plugged, air bubbles within the dispensing system 14, and the like can be continuously monitored and compensated for.

Of course, this process continues indefinitely for the duration of the dispensing application. In the preferred embodiment, a new value for the compensation factor is determined after each pulse 34 is transmitted by the flow meter 32, i.e., the compensation factor f is recalculated after each pulse 34. In other words, the previous description of how to determine the first f₁ and second f₂ new values for the compensation factor f is merely illustrative of the steps carried out to recalculate the compensation factor f after each pulse 34. In fact, the compensation factor f could be recalculated hundreds or thousands of times during the dispensing application.

Additional Compensation

In addition to recalculating and using the compensation factor f during normal operation of the dispensing system 14, other compensation routines can be performed by the controller 48 to ensure that the actual dispensing rate is within the minimum deviation of the target dispensing rate.

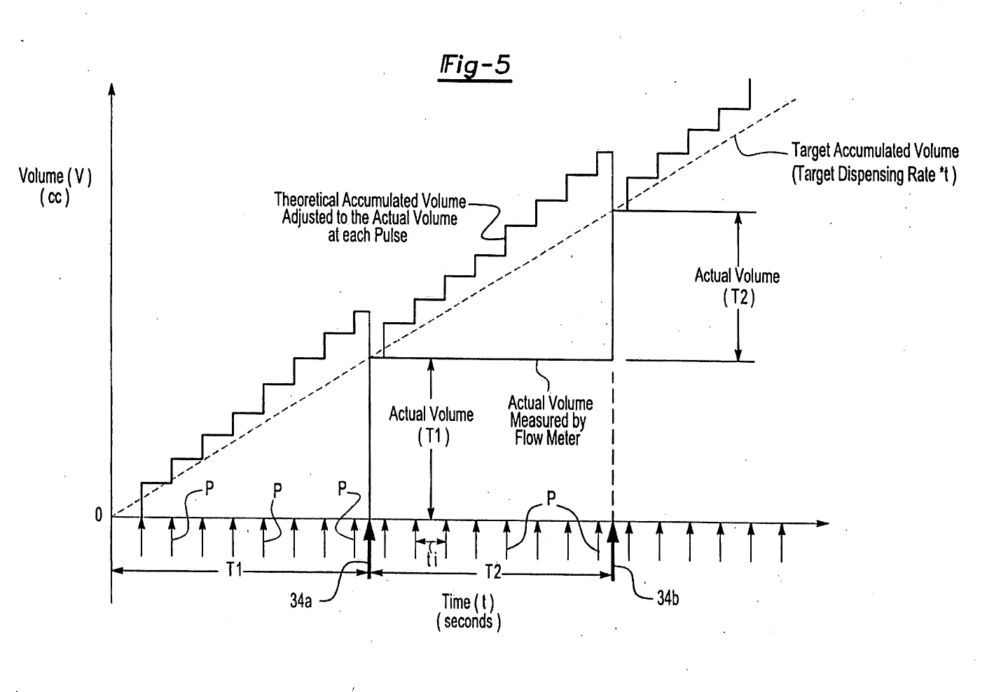

In the preferred embodiment, a theoretical accumulated volume of the viscous material 10 dispensed over the first T1 and second T2 time periods is determined. Referring to FIG. 5, the theoretical accumulated volume is based on both the theoretical volume and the actual volume. In particular, the theoretical accumulated volume is based on the theoretical volume between pulses 34a, 34b, and the actual volume at each pulse 34a, 34b. In other words, the theoretical accumulated volume is estimated between pulses 34a, 34b using the equation,
theoretical accumulated volume=Σ^{t}[(Pₜᵢ−b)/f]^{N}
wherein f is the applicable value for the compensation factor f, i.e., fᵢₙᵢₜᵢₐₗ for the first time period T1 and f₁ for the second time period T2, b is the cracking pressure, Pₜᵢ is the pressure measurement taken at each time increment ti within the time periods T1, T2, and N is the linearity factor. The theoretical accumulated volume is adjusted at each pulse 34a, 34b to a total actual volume of viscous material 10 dispensed based on the preset volume of the flow meter 32, as illustrated in FIG. 5.

A target accumulated volume of the viscous material 10 dispensed over the first T1 and second T2 time periods is determined based on the target dispensing rate, e.g., the target dispensing rate*time. These accumulated volumes are then compared and the voltage of the output signal 46 applied to the variable orifice servo valve 44 is further adjusted based on the difference between the theoretical accumulated volume and the target accumulated volume. In particular, referring to FIG. 1, the difference is multiplied by a second voltage constant K₁ to determine the second voltage adjustment 54. The second voltage adjustment 54 is an addition or reduction in the voltage of the output signal 46 applied to the variable orifice servo valve 44. Hence, the voltage applied to the variable orifice servo valve 44 via the output signal 46 is equal to the base voltage 50 plus the first 52 and second 54 voltage adjustments. The first voltage adjustment 52, as with the second voltage adjustment 54, is executed after each pressure measurement P, or every 0.008 seconds.

Error Detection

The compensation factor f can also be used to detect changes in the operational characteristics of the dispensing system 14. In particular, if changes in the value for the compensation factor f between pulses 34 exceeds a predetermined limit, e.g., if the difference between the first new value f₁ for the compensation factor f and the second new value f₂ for the compensation factor f exceeds the predetermined limit, the nozzle 26 may be plugged and the controller 48 may send an indicator signal to an operator of the dispensing system 14 indicating the same. In addition, the controller 48 may shut down the dispensing system 14 until the condition is returned to normal, i.e., the nozzle 26 is unplugged.

The compensation factor f could similarly be used to detect air bubbles within the dispensing system 14 based on the difference between the first f₁ and second f₂ new values for the compensation factor f. For instance, a second predetermined limit may be defined to detect air bubbles with the dispensing system 14. In other words, a plugged nozzle or air bubbles in the dispensing system 14 can be detected by a large change in the compensation factor f within a short time period.

The compensation factor f could similarly be used to detect undesired “gumdrop” dispensing, i.e., when large drops of the viscous material 10 are dispensed onto the workpiece 12 as opposed to a steady flow.

In addition, wear of the nozzle 26 of the dispensing system 14 could be detected based on exceeding a predefined limit for the value for the compensation factor f. The predefined limit being a value of the compensation factor f in which the nozzle 26 is close to being worn and must be replaced due to excessive wear. In one embodiment of this feature, the controller 48 may calculate a trend line for each successively determined value of the compensation factor f during the dispensing application. If the trend line does not sharply move, e.g., indicating that the nozzle 26 is plugged or air bubbles are in the dispensing system 14, and the trend line passes through the predefined limit, i.e., exceeds the predefined limit, an indicator signal maybe sent to the operator indicating that the nozzle 26 should be replaced.

Alternative Embodiments

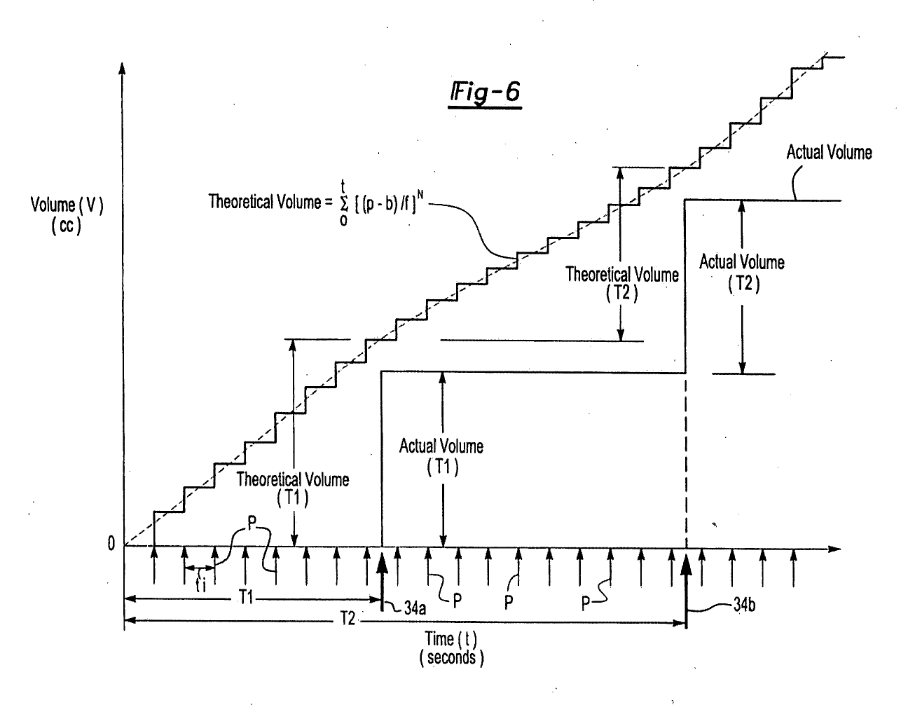

In an alternative embodiment, illustrated in FIG. 6, a portion of the second time period T2 overlaps the first time period T1 such that the second time period T2 includes the first time period T1 to compensate the actual dispensing rate for changes in the operating characteristics of the viscous material 10 and the dispensing system 14 thereby maintaining the actual dispensing rate within the minimum deviation of the target dispensing rate. This alternative may provide a better averaging method for the compensation factor f by utilizing more historical pressure and volume data. Other than the difference in the time periods used in the previously outlined steps, all other steps from the previous embodiment are carried out in this embodiment.

Obviously, many modifications and variations of the present invention are possible in light of the above teachings. The invention may be practiced otherwise than as specifically described within the scope of the appended claims. The novelty is meant to be particularly and distinctly recited in the “characterized by” clause whereas the antecedent recitations merely set forth the old and well-known combination in which the invention resides. These antecedent recitations should be interpreted to cover any combination in which the novelty exercises its utility. In addition, the reference numerals in the claims are merely for convenience and are not to be read in any way as limiting.

An alternative technique for controlling system 14 uses a least squares method to calculate repetitively the magnitudes of both the compensation factor and cracking pressure. N is assigned a constant value. FIG. 7 contains graphs representing the trend of delivery rate-fluid pressure data sets that would result with values of N that are greater than, less than and equal to unity. Preferably, N is assigned a value that corresponds to expected trends of the delivery rate-fluid pressure data sets. The target dispensing or fluid flow rate equation
Target Flow Rate=[(Pressure−b)/f]^{N} (1)
is modified to the following equation
D=F*P+B (2)
wherein:
D is the (Theoretical Flow Rate)ⁿ
n=1/N, a constant;
P is fluid pressure;
F=fⁿ; and
B=−F*b

At the occurrence of every time increment ti, approximately every 8 msec, the controller 48 receives a pressure signal 40, converts the signal to a pressure magnitude P, and stores the pressure magnitude P in electronic memory accessible to the microprocessor 49. At the occurrence of the next pulse 34 produced by the delivery flow meter 32, the controller 48 calculates the average delivery or fluid flow rate Dₐᵥₑ through the delivery flow meter 32, and the average pressure magnitude Pₐᵥₑ from the pressure signals that have occurred at each increment ti since a prior pulse 34. Preferably, the pressure and flow rate magnitudes are averaged over a period during which several delivery meter pulses 34 have occurred. The pressure and delivery rate values are also recorded in electronic memory. After several sets of (P, D) values are obtained, the coefficients F and B are calculated using a least square method.

The values of F and B in Equation (2) are calculated as follows:
F=Spd/Spp; and B=DₐᵥₑF*Pₐᵥₑ
wherein
Pₐᵥₑ=P average=(1/t)ΣP;
Dₐᵥₑ=D average=(1/t)ΣD;
Spp=ΣP²−(1/t) (ΣP)²;
Spd=ΣPD−(1/t)(ΣP)(ΣD); and
t is the number of time increments.

The controller 48 performs calculations using data acquired over a period containing several delivery meter pulses 34, instead of using pressure data of only one previous pulse from the delivery flow meter 32. The controller 48 calculates, not only the compensation factor F, but also the pressure bias/cracking pressure B.

The controller 48 only retains a certain number of old (P, D) data sets so that only the recent measurement data reflect viscosity changes of the material. In order to accomplish this, the recorded P and D data are retained in a ring buffer having a predefined size. During one pulse increment, the controller 48 uses the average value for the measured pressure. Provided the relationship between D and P is linear, this averaging is permitted.

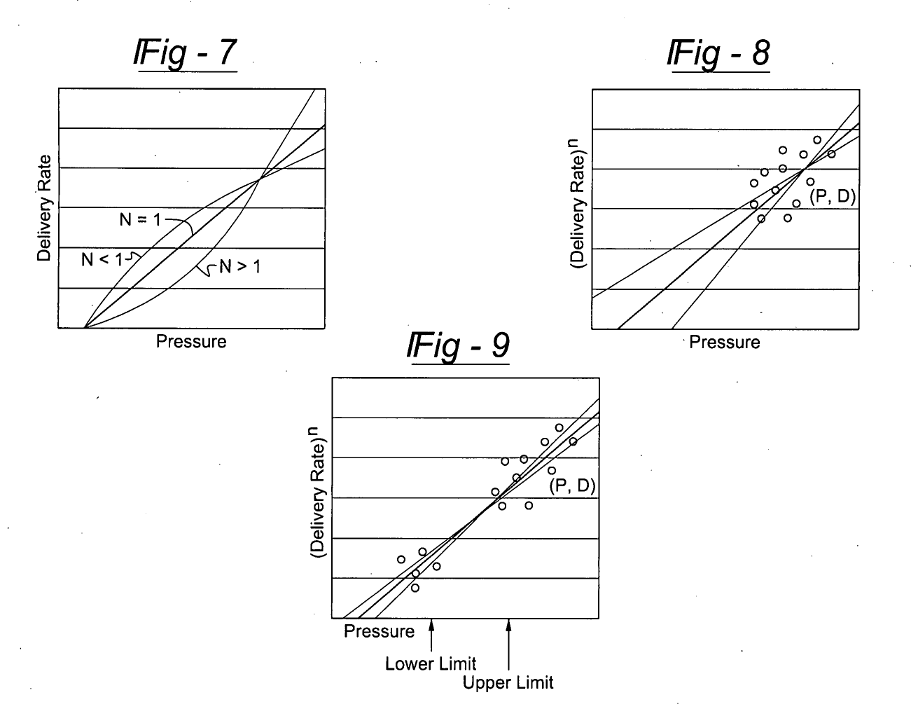

In order to have accurate values of the coefficients B and F, it is important to have well spread sets of (P, D) data. If the material delivery occurs at a constant rate for a prolonged time, the pressure and delivery rate will be within a narrow range, as shown in FIG. 8. In order to avoid such cases, the ring buffer contains data over a wider range of delivery rate and pressure sets. The system always keeps a certain number of low and high pressure/delivery data sets, the lower limit and upper limit values of FIG. 9. This technique ensures accurate coefficient values using the least square method.

If the number of pressure and delivery data sets at a lower rate decreases to a predetermined number, the buffer ring no longer records and retains the data at a higher rate. Similarly, if the number of pressure and delivery data sets at a higher rate decreases to a predetermined number, the ring no longer records and retains the data at a lower rate. This ensures that the ring buffer always contains data at a lower rate and a higher rate so that accurate coefficients are calculated.

When the delivery meter measures a flow rate higher than the one given by Equation (2) for the measured pressure, the system 14 posts a “Bubble Detected” alarm. Similarly, when the delivery meter 32 measures a flow rate lower than the one given by Equation (2) for the measured pressure, the system posts a “Partially Plug-tip Detected” alarm.

In addition, if the delivery meter pulse 34 does not arrive for a prolonged period, predicted by Equation (2), then the system posts a “Plugged Tip” alarm.

The system retains reference values, F₀ and B₀, of F and B in order to determine whether the nozzle is excessively worn.
D=Fo*P+Bo (3)
If the latest calculated F and B values result in a calculated theoretical flow rate that is greater than the flow rate from Equation (3), then the system posts a “Worn Out Nozzle” alarm.

The number of delivery conduits or guns 20 is a part of the material delivery system. The number of operating guns 20 directly affects the delivery rate D; therefore, use of multiple guns needs special consideration. If g is the number of guns operating at a given time, and all the guns have the same nozzle size, then Equation (2) becomes,
D/g=F*P+B (4)

Equation (4) assumes that the resistance within the gun hose or conduit 20 is negligible, and the number of guns g that are opened for one delivery meter increment T is unchanged. In Equation (4), upon replacing D/g with D, the same least square method calculation can be applied to a system operating with multiple guns operating concurrently. If the number of guns changes during a time increment, then the measurement data for that period are discarded.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A fluid dispensing system for dispensing a fluid onto an workpiece through an output at a target flow rate, comprising:
a controllable pressure regulating device through which fluid under pressure flows to the output;
a pressure sensor providing a pressure signal representing a fluid pressure at the output;
a flow meter providing a flow rate signal representing a flow rate of fluid through the output; and
a controller responsive to the flow rate signal, for controlling the pressure regulating device to produce a pressure corresponding to the target flow rate, the target flow rate and the pressure signal being related by a compensation factor and a cracking pressure calculated by the controller on the basis of the flow rate represented by the flow rate signal and the fluid pressure represented by the pressure signal.

2. The system of claim 1, wherein the pressure regulating device includes a servo valve including an orifice having a variable cross sectional area, through which fluid under pressure flows to the output.

3. The system of claim 1, further comprising a robot having a robot arm for controlling a position of said output relative to the workpiece.

4. The system of claim 1, wherein said pressure regulator includes a variable orifice servo valve, and the controller is programmed for regulating the variable orifice servo valve using a difference between the target flow rate and the flow rate through the output represented by the flow rate signal.

5. The system of claim 1, further comprising:
a delivery conduit; and
a pump coupled to the delivery conduit for conveying the fluid through the delivery conduit to the output.

6. The system of claim 1, further comprising:
a robot having a robot arm for controlling a position of the output relative to the workpiece, the robot defining six rotational axes for rotating one of the output and the workpiece thereabout.

7. A method of controlling a fluid delivery system that includes a controllable pressure regulating device, through which fluid under pressure flows to an output, said method comprising the steps of:
establishing an initial compensation factor and an initial cracking pressure;
measuring a pressure of the fluid at each of a plurality of time increments occurring while the fluid is dispensed;
determining a volume of the fluid dispensed during a first period;
determining an average pressure at the time increments during the first period;
determining an average flow rate during the first period;
determining, from the average pressure value and the average flow rate value during the first period, a new compensation factor and a new cracking pressure;
using the new compensation factor, the new cracking pressure, and the pressure measurements during a second period to determine a theoretical flow rate of the fluid for the second period; and
using a difference between the theoretical flow rate and the target flow rate to control the pressure regulating device to produce a pressure corresponding to the target flow rate.

8. The method of claim 7 wherein the step of measuring a pressure of the fluid, further comprises:
receiving a control signal from a pressure sensor after each of the time increments; and
converting the control signals to the pressure measurements.

9. The method of claim 8 wherein the step of determining the actual volume of the fluid dispensed during the first period further comprises:
receiving first and second electrical pulses generated by a flow meter of the delivery system, the first pulse indicating that a preset volume of the fluid has passed through the flow meter during a first duration, and the second pulse indicating that the preset volume of the fluid has passed through the flow meter (32) during a second duration, the first and second durations extending for the first period.

10. The method of claim 9, further comprising determining the theoretical flow rate after each pressure measurement is taken.

11. The method of claim 10, further comprising:
comparing the theoretical flow rate to the target flow rate; and
adjusting a voltage applied to a variable orifice servo valve of the pressure regulator based on a difference between the theoretical flow rate and the target flow rate.

12. The method of claim 11, further comprising:
determining a theoretical accumulated volume of the fluid dispensed during the first period; and
determining a target accumulated volume of the fluid dispensed during the first period.

13. The method of claim 12, further comprising:
comparing the theoretical accumulated volume and the target accumulated volume; and
adjusting the voltage applied to the variable orifice servo valve based on a difference between the theoretical accumulated volume and the target accumulated volume.

14. The method as set forth in claim 7, wherein the steps of establishing an initial cracking pressure and determining a cracking pressure includes determining a pressure representing frictional losses in the delivery system to be overcome by the fluid in order to begin dispensing fluid onto a workpiece.

15. The method of claim 14, further comprising:
establishing a linearity factor (N) for the fluid representing shear thinning or shear thickening properties of the fluid.

16. The method of claim 15, wherein the step of determining the theoretical flow rate of the fluid, further includes:
determining the theoretical flow rate using the relationship D=F*P+B, wherein D is the (theoretical flow rate)ⁿ n=1/N , a constant; P is fluid pressure; F=fⁿ; and B=−F*b; b is the cracking pressure; f is the compensation factor; and n is a linearity factor.

17. The method of claim 16, wherein the values of F and B are calculated using F=Spd/Spp; and B=DₐᵥₑF*Pₐᵥₑ, wherein Pₐᵥₑ=(1/t)ΣP; Dₐᵥₑ=(1/t)ΣD; Spp=ΣP²−(1/t)(ΣP)²; Spd=ΣPD−(1/t)(ΣP)(ΣD); and t is the number of time increments.

18. The method of claim 7, further comprising:
detecting an obstruction in the delivery system based on a difference in a flow rate indicated by a flow meter and a theoretical flow rate that is less than the flow rate indicated by the a flow meter.

19. The method of claim 7, further comprising:
detecting air bubbles in the delivery system based on the difference in a flow rate indicated by a flow meter and a theoretical flow rate that is greater than the flow rate indicated by the a flow meter.

20. The method of claim 7, further comprising:
establishing reference values of the compensation factor and cracking pressure; and
detecting wear of a nozzle of the delivery system (14) based on a first theoretical flow rate determined using the reference values of the compensation factor and the cracking pressure and the pressure measurements for a period, and a second theoretical flow rate determined using a new compensation factor and a new cracking pressure and pressure measurements for said period that is greater than the first theoretical flow rate.

21. The method of claim 7, wherein the entire second period occurs consecutively with the first period to compensate an actual flow rate during the second period for changes in an operational characteristic of the fluid and the delivery system that occur during the first period, thereby maintaining the actual flow rate within a minimum deviation of the target flow rate during the second period.

22. The method of claim 7, wherein a portion of the second period overlaps the first period to compensate an actual flow rate during the second period for changes in an operational characteristic of the fluid and the delivery system that occur during the first period, thereby maintaining the actual flow rate within a minimum deviation of the target flow rate.
